(19) United States
(12) Patent Application Publication
(10) Pub. No.: US 2021/0066981 A1
(43) Pub. Date: Mar. 4, 2021

(54) ROTOR FOR AN ELECTRIC MACHINE WITH WEB-SHAPED HOLDING ELEMENTS

(71) Applicant: VOLKSWAGEN AKTIENGESELLSCHAFT, Wolfsburg (DE)

(72) Inventors: Holger FRIES, Goslar (DE); Ralf LÜDERS, Peine (DE); Behrend BODE, Peine (DE); Florian BOSENIUK, Hannover (DE)

(73) Assignee: VOLKSWAGEN AKTIENGESELLSCHAFT, Wolfsburg (DE)

(21) Appl. No.: 17/011,426

(22) Filed: Sep. 3, 2020

(30) Foreign Application Priority Data
Sep. 4, 2019 (DE) 10 2019 213 448.3

(51) Int. Cl. H02K 1/28; H02K 1/27; H02K 21/14

(52) U.S. Cl. CPC H02K 1/28; H02K 21/14; H02K 1/278

(57) ABSTRACT

A rotor for an electric machine has a rotor shaft, a core that is non-rotatably connected to the rotor shaft and that surrounds the rotor shaft, and a plurality of permanent magnets connected to the core in a ring-shaped arrangement on the outside. Each of a plurality of web-shaped holding elements covers at least one of the permanent magnets on the outside such that said holding elements cover each of the associated permanent magnet(s), either on their outer surface exclusively in a section that is located centrally relative to the circumferential direction of the rotor or else exclusively on a side surface of each permanent magnet. Consequently, the holding elements should at least not cover the edges of the permanent magnets where the appertaining outer surfaces make a transition into one of the associated side surfaces. This allows the smallest possible magnetically active distance to be created between the permanent magnets of the rotor and an associated stator.

### CROSS REFERENCE TO RELATED APPLICATION

This application claims priority from German Patent Application No. 10 2017 209 693.4 filed Sep. 4, 2019, the contents of which are incorporated herein by reference.

### FIELD OF THE INVENTION

The invention relates to a rotor for an electric machine, especially for an electric motor or an electric generator, having a rotor shaft, having a core that is non-rotatably connected to the rotor shaft and that surrounds the rotor shaft, and having a plurality of permanent magnets that are connected to the core in a ring-shaped arrangement on the outside.

### SUMMARY OF THE INVENTION

The permanent magnets of such a rotor have to be connected to the core in such a way that they are secured from being lost during operation of an electric machine that has the rotor. This is normally done by means of a sheath which is made of metal or plastic and which surrounds the permanent magnets and the core, or else by inserting the permanent magnets into pockets provided in the core for this purpose. Such sheaths for the permanent magnets, however, mean that the magnetically relevant distance that is created between the permanent magnets of the rotor and the electric windings of the stator that surrounds the rotor has to be selected so as to be relatively large, since this distance is determined not only by the gap needed for contactless rotation of the rotor inside the stator but also by the radial thickness of the sheath. A relatively large magnetically relevant distance, however, translates into a relatively poor efficiency of the electric machine.

In order to keep the resulting drawbacks to a minimum, an attempt is normally made to configure the sheath with the smallest possible radial thickness. This, however, is only possible to a certain extent, for example, in case of a sheath that has been made of plastic by means of injection molding, which normally requires wall thicknesses of at least 0.5 millimeters. Moreover, sheaths with very thin walls that are produced as separate components and that are pulled over the permanent magnets that have already been connected to the core are extremely susceptible to damage during the assembly of the rotors, an aspect that detrimentally affects the assembly process.

An electric machine which has a sheath made of metal and which can be configured either as a solid hollow cylinder or with a cage structure is disclosed in German patent specification DE 38 44 074 C2.

Moreover, German patent application DE 43 31 803 A1 discloses an electric motor in which, for purposes of facilitating the assembly of the rotor, the permanent magnets are held on a support by means of holding clamps, whereby the holding clamps have web-shaped sections that extend into indentations in the permanent magnets on the outside. In addition to this, also in the electric motor according to DE 43 31 803 A1, the permanent magnets are attached to a core of the rotor by means of a sheath that surrounds said permanent magnets as well as the holding clamps.

When it comes to an electric machine, the invention is based on the objective of minimizing the magnetically relevant distance between the permanent magnets of the rotor and the stator of the electric machine in the most advantageous manner possible in order to attain the highest possible efficiency of the electric machine.

### SUMMARY OF THE INVENTION

This objective is achieved by means of an electric machine comprising a rotor as claimed. Advantageous embodiments of such a rotor according to the invention and of such an electric machine according to the invention are subject matters of the additional patent claims and/or ensue from the description of the invention below.

According to the invention, a rotor is being put forward for an electric machine, especially for an electric motor (for example, for a drive motor of a pump in a motor vehicle) or for an electric generator, having a rotor shaft, having a core that is non-rotatably connected to the rotor shaft and that surrounds the rotor shaft, and having a plurality of permanent magnets that are connected to the core in a ring-shaped arrangement on the outside. In this context, a plurality of web-shaped holding elements are provided, each of which covers at least one of the permanent magnets on the outside, especially so as to make direct contact. Here, it can be provided that the holding elements (or at least some of them) extend over only a section or over the entire lengthwise extension of the associated permanent magnet(s). According to the invention, it is also provided for the holding elements to cover each of the associated permanent magnet(s), either on their outer surface exclusively in a section that is located centrally relative to the circumferential direction of the rotor (preferably also encompassing the exact middle) or else exclusively on a side surface of each permanent magnet.

Consequently, the holding elements should at least not cover the edges of the permanent magnets where the appertaining outer surfaces make a transition into one of the associated side surfaces, said edges preferably running parallel along the axis of rotation of the rotor. This allows the smallest possible magnetically active distance to be created between the permanent magnets of a rotor according to the invention and the stator of an electric machine according to the invention that is preferably arranged coaxially thereto. If the permanent magnets are surrounded or covered on the outside exclusively by the holding elements—as this is preferably provided—the (smallest) distance between the permanent magnets and the stator can even be reduced all the way to the radial height of the specific gap that is necessary for a contactless rotation of the rotor relative to the stator, taking into consideration shape and position tolerances.

In order to cover the permanent magnets by means of at least some of the holding elements exclusively on a side surface for each permanent magnet, the side surfaces have to be shaped, at least in certain sections, in such a way that they do not run exactly radially relative to the axis of rotation of the rotor. This can be achieved, for example, in that the side surfaces, or at least certain sections thereof, each run in a plane that is not oriented exactly radially relative to the axis of rotation of the rotor. By the same token, it is possible to provide a step-like course of the side surfaces or undercuts (relative to the radial direction) in the side surfaces. Before this backdrop, the term outer surface of the permanent magnets refers to the surface that delimits the appertaining permanent magnets situated radially on the outside and that, in this process, delimits to a large extent, especially by at least 80% or 90%, the cross-sectional surface of these permanent magnets relative to the circumferential direction.

An embodiment of the rotor according to the invention, in which the holding elements cover the appertaining permanent magnets at least on their outer surface in a section that is in the middle relative to the circumferential direction of the rotor, can be implemented especially advantageously when the permanent magnets have rectangular cross-sectional surfaces. Such permanent magnets, which are also known as block magnets, find widespread use in electric machines since they can be produced cost-effectively. A drawback of such permanent magnets, however, lies in the fact that they define an outer circumference of the rotor whose cross section corresponds approximately to a polygon, something which, in combination with a stator that delimits an essentially cylindrical inner volume—as is also preferably provided in an electric machine according to the invention—causes the distance between the permanent magnets and the stator to be irregular along the circumference of the rotor and, relative to the circumferential direction of rotor, to be the largest, or at least relatively large, in the middle of the individual permanent magnets. Therefore, according to the invention, especially these sections of the outer surfaces of the permanent magnets can be advantageously utilized in order to achieve an at least radially effective connection of the permanent magnets to the core by means of a covering contact with the holding elements. In this context, the covering or contacting of these sections by the holding elements is not disadvantageous in terms of attaining the smallest possible magnetically effective distance since the smallest distance in permanent magnets with rectangular cross-sectional surfaces is already situated in the area of the edges that make the transition between the outer surfaces and the side surface of the permanent magnets. Therefore, the holding elements do not prevent this smallest distance from being reduced to the dimension required for contactless operation.

In order to attain the best possible connection of the permanent magnets to the core, it can preferably be provided, for instance, for holding elements that cover each of the associated permanent magnets exclusively on one side surface to also be provided for those permanent magnets that have rectangular cross-sectional surfaces.

If the permanent magnets have cross-sectional surfaces in the form of circular ring segments, it is practical to provide exclusively holding elements that cover each of the associated permanent magnets exclusively on one side surface. The smallest distance between the permanent magnets and the stator can then preferably be present over the entire outer surface of the permanent magnets.

In a preferred embodiment of a rotor according to the invention, it can be provided for the holding elements or at least some of them to extend from the two front faces or lengthwise axial end faces of the core only in certain sections over the lengthwise extension of the associated permanent magnet(s), said extension running along the axis of rotation of the rotor. In this context, it can also be preferably provided that, in each case, two holding elements coming from different front faces are connected to each other directly or indirectly in such a way that they reciprocally support a radial load onto these holding elements that is oriented towards the outside. This translates into a sufficiently secure connection of the permanent magnets to the core of the rotor, even with holding elements that have been dimensioned to be relatively weak or flexible.

In a likewise preferred embodiment of a rotor according to the invention, it can be provided for each holding element or at least some of them to extend over the entire lengthwise extension of the associated permanent magnet(s), and for them to be connected to each other directly or indirectly at one or both front faces of the permanent magnets in such a way that they reciprocally support a radial load onto these holding elements that is oriented towards the outside. This also translates into a sufficiently secure connection of the permanent magnets to the core of the rotor, even with holding elements that have been dimensioned to be relatively weak or flexible.

Fundamentally, there is also the possibility for each holding element or at least some of them to extend exclusively from one of the front faces and for them to end freely at the corresponding other axial end. For this purpose, however, the holding elements should be configured to be relatively sturdy or stiff under flexural load, so as to achieve a sufficiently secure connection of the permanent magnets to the core of the rotor.

In another preferred embodiment of a rotor according to the invention, it can be provided for all of the holding elements or at least some of them to be attached to a connecting ring, at least at one of their lengthwise axial ends. This attachment can be detachable or undetachable, or else in one piece.

In an especially preferred embodiment of such a rotor according to the invention, it can be provided for one of the lengthwise axial ends of all of the holding elements to be attached to such a connecting ring, especially so that it cannot be detached. This allows all of the holding elements to be simultaneously mounted in an arrangement that is secured by the connecting ring, or for them to be pushed onto the already pre-mounted combination of the core and the permanent magnets. Subsequently, the other lengthwise axial ends of the holding elements can be additionally secured, for instance, by means of a detachable attachment to a second connecting ring or by being connected to each other.

It can also be advantageously provided for the holding elements and/or the connecting ring(s), if these are present, to be made of one or more plastics (preferably PPS). This allows them to be produced cost-effectively, especially by means of injection molding. Moreover, as a result, these components can be relatively lightweight.

### BRIEF DESCRIPTION OF THE DRAWINGS

The invention will be elaborated upon in greater detail below on the basis of embodiments shown in the drawings. The drawings show the following, at times in a simplified depiction:

FIG. 1 shows a rotor for an electric machine according to the state of the art, in a perspective view;

FIG. 2 shows a cross sectional view through a section of the rotor as shown in FIG. 1;

FIG. 3 shows a cross sectional view through a section of a rotor according to the invention in a first embodiment;

FIG. 4 shows an electric machine according to the invention, having a rotor as shown in FIG. 3, in a partial cross-sectional view;

FIG. 5 shows the rotor of the electric machine as shown in FIG. 4, in a perspective depiction;

FIG. 6 shows a rotor according to the invention, in a second embodiment, in a side view;

FIG. 7 shows a rotor according to the invention, in a third embodiment, in a perspective view;

FIG. 8 shows the rotor as shown in FIG. 7, in a view from the rear; and

FIG. 9 shows a rotor according to a fourth embodiment, in a view from the rear.

### DETAILED DESCRIPTION OF THE INVENTION

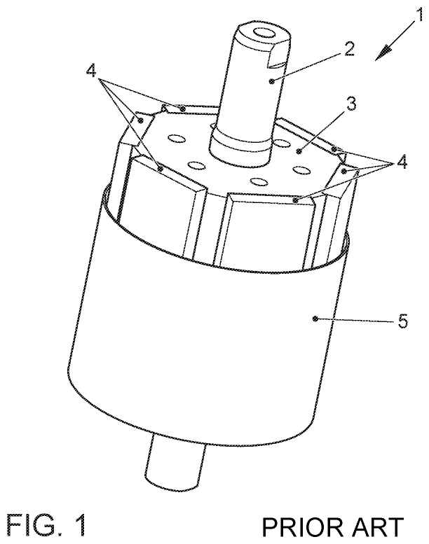

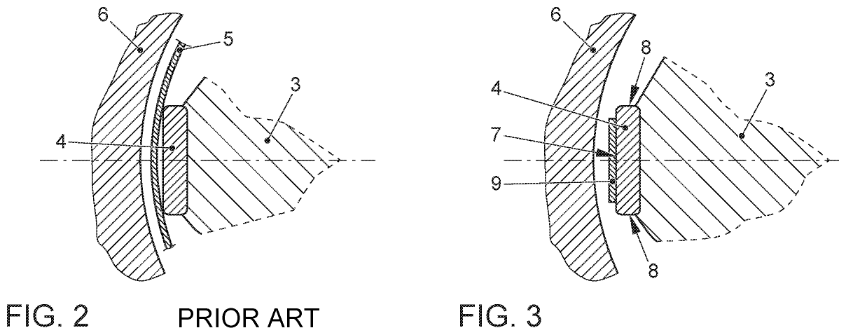

FIGS. 1 and 2 show a rotor 1 for an electric machine according to the state of the art. This rotor 1 has a rotor shaft 2, a core 3 that is non-rotatably connected to the rotor shaft 2 and that surrounds the rotor shaft 2, and a plurality of permanent magnets 4 which are configured as block magnets and which consequently have rectangular cross-sectional surfaces. In this context, the permanent magnets 4 are connected to the core 3 in a ring-shaped arrangement on the outside. At least one tubular sheath 5, which can be made, for example, of metal or plastic and which is shown only partially in FIG. 1, also serves to connect the permanent magnets 4 to the core 3.

In such a rotor 1 according to the state of the art, there is a relatively large magnetically active distance between the permanent magnets 4 of the rotor 1 and a stator 6 of an electric machine comprising one of these two components since, in the structural configuration of the smallest distance between the permanent magnets 4 and the stator 6, on the one hand, a gap width between the sheath 5 and the stator 6 has to be dimensioned so large that it prevents contact between the rotor 1 and the stator 6, taking into consideration the permissible shape and position tolerances and, on the other hand, the radial thickness of the sheath 6 [sic] has to be taken into consideration.

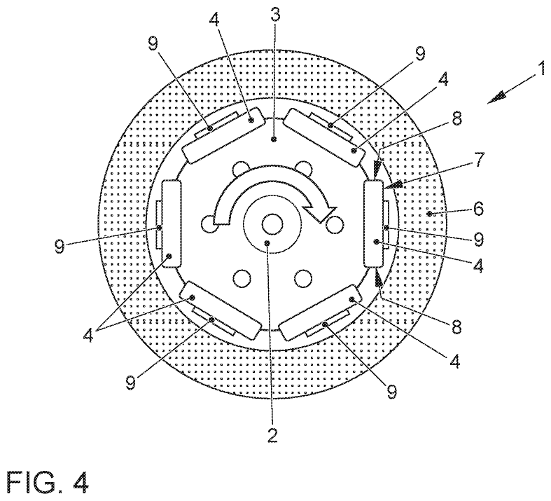

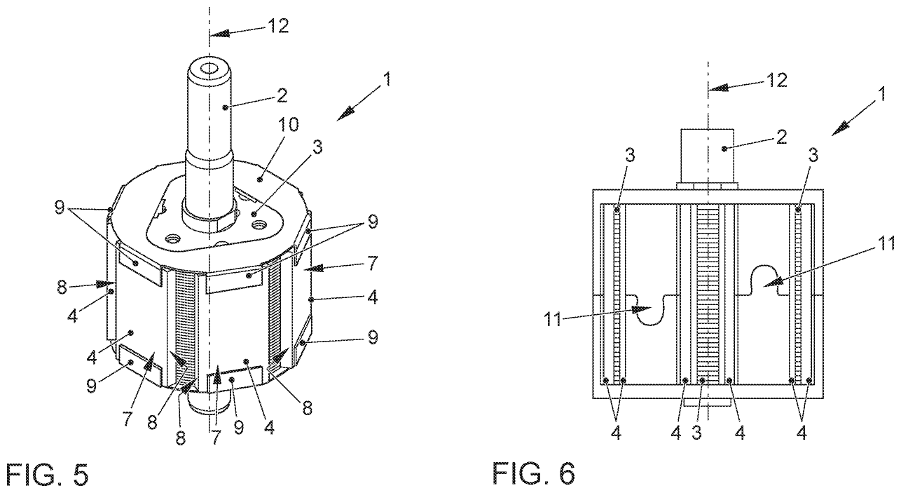

A rotor 1 according to the invention, as is shown in various embodiments in FIGS. 3 to 9, avoids this drawback in that no sheath or covering of the permanent magnets is provided in the area of those edges where the outer surfaces 7 of the permanent magnets 4 having rectangular cross-sectional surfaces make a transition into each of the associated side surfaces 8 and have the smallest distance to the stator 6. Accordingly, the distance between the permanent magnets 4 and the stator 6 can be reduced to such an extent that, in the area of these edges, the distance between the permanent magnets 4 and the stator 6 corresponds to the gap width that has to be structurally provided in order to prevent contact between the rotor 1 and the stator 6, taking into consideration permissible shape and position tolerances. A comparison of FIGS. 2 and 3 illustrates this result.

In the embodiments of the rotors 1 according to the invention shown in FIGS. 3 to 9, which are each to be combined with a stator 6 that delimits a cylindrical inner volume, this objective of attaining the smallest possible (minimal) distance between the permanent magnets 4 and the stator 6 is achieved in that web-shaped holding elements 9 are provided, each of which covers at least one of the permanent magnets 4 on the outside in certain sections, thus making contact, whereby the holding elements 9 cover the appertaining permanent magnet(s) 4, either on their outer surface 7 exclusively in a section that is located centrally and especially exactly in the middle relative to the circumferential direction of the rotor 1 or else exclusively on a side surface 8 of each permanent magnet 4.

In the configuration of a rotor according to the invention as shown in FIGS. 3 to 6, two holding elements 9 are provided for each permanent magnet 4, whereby a first holding element 9, starting at a first front face, and a second holding element 9, starting from a second front face of the appertaining permanent magnet 4 or the core 3, extend over a section of the lengthwise extension of the appertaining permanent magnet 4 and in this process, cover the outer surface 7 of each associated permanent magnet 4. In this context, all of the holding elements 9 that extend from the first front faces of the permanent magnets 4 or from the first front face of the core 3 are connected to a first connecting ring 10 and are concretely configured in one piece with it, whereby this connecting ring 10 rests loosely on the corresponding front faces of the permanent magnets 4 and of the core 3. In the same manner, all of the holding elements 9 that extend from the second front faces of the permanent magnets 4 and of the core 3 are connected to a second connecting ring 10.

The embodiment of a rotor 1 according to the invention shown in FIGS. 3 to 5 differs from that shown in FIG. 6 to the effect that in the latter, the holding elements 9 are configured so as to be relatively short so that they extend only over a section of the lengthwise extension of each appertaining permanent magnet 4 that is considerably smaller than half of this lengthwise extension. Consequently, the ends of the holding elements 9 that cover the appertaining permanent magnets 4 are configured freely. In order to attain a sufficiently secure connection of the permanent magnets 4 to the core 3 by means of such holding elements 9, these holding elements 9 should be dimensioned to be relatively sturdy or stiff under flexural load. For this purpose, it lends itself for the holding elements 9 as well as for the connecting rings 10 that are formed in one piece with them to be made of metal.

In the case of the rotor 1 shown in FIG. 6, in contrast, it is provided for the individual holding elements 9 to each extend over half of the lengthwise extension of the appertaining permanent magnet 4, so that each of the two holding elements 9 that are associated with a permanent magnet 4 abut each other or contact each other in the lengthwise axial middle of the permanent magnet 4. In this context, a connection is additionally provided between each of these two holding elements 9 for each permanent magnet 4, namely, in the form of a combination of a recess in one of these holding elements 9 and a projection 11 of the other holding element 9 that engages with this recess. This combination achieves that, on the one hand, a radial load onto the holding elements 9—occurring especially due to centrifugal forces when the rotor 1 rotates—is reciprocally supported by the two holding elements 9. In order to implement such an effective support of the two holding elements 9 of each permanent magnet 4 in the radial direction relative to the axis of rotation 12 of the rotor 1, it is possible, for example, to provide that the delimitation surfaces of the recesses and projections 11 located at the edge should have complementary bevels (not visible).

Owing to the reciprocal support of each of the two holding elements 9 for each permanent magnet 4, the individual holding elements 9 can be dimensioned so as to be weaker or more flexible. This especially allows the holding elements 9 as well as the associated connecting rings 10 to be advantageously made of plastic, for example, as injection-molded components. On the other hand—owing to the combinations of intermeshing projections 11 and recesses, which moreover, as mentioned, are configured in such a way as to yield effective form-fitting connections relative to the lengthwise extensions of the holding elements 9—a lengthwise axial positional fixation is achieved for the holding elements 9 or else for the appertaining combinations of holding elements 9 and the connecting ring 10 that is formed in one piece with said holding elements 9 relative to the permanent magnets 4 and to the core 3 that supports them. In an advantageous manner, other measures with which such a lengthwise axial positional fixation can be realized, especially the appertaining effective connections of the connecting rings 10 to the core 3, can be dispensed with. This is advantageously reflected in the production costs for such a rotor 1 according to the invention.

As an alternative or in addition to the form-fitting connection of each of the appertaining two holding elements 9 that are associated with one of the permanent magnets 4, it can also be especially provided for these holding elements 9 to be integrally bonded to each other, for instance, to be glued or welded together.

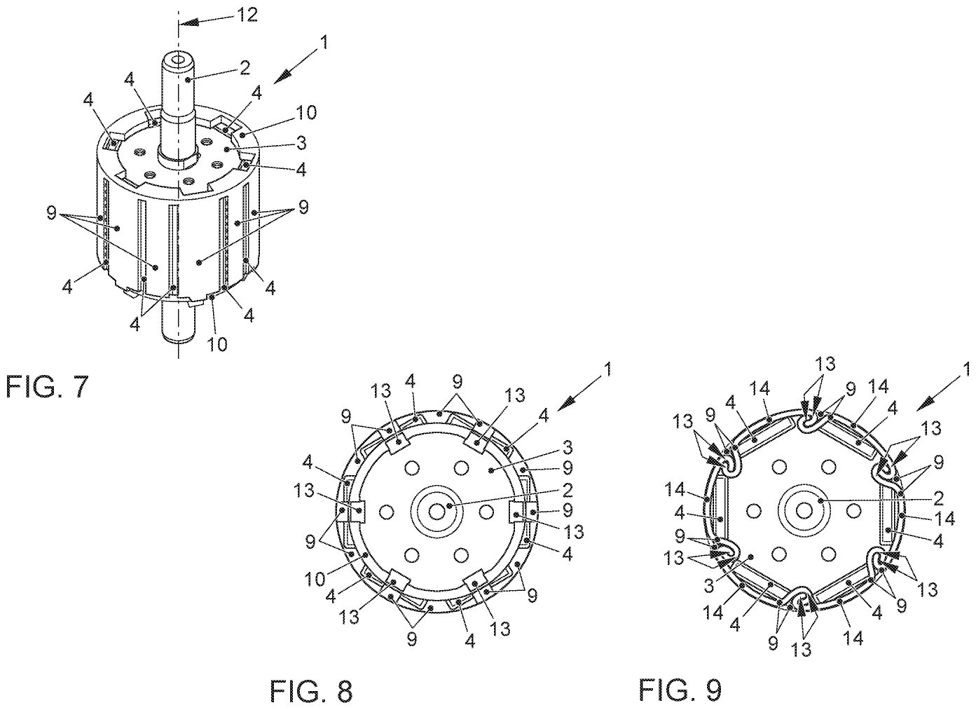

In the case of the embodiments of the rotors 1 according to the invention shown in FIGS. 7 to 9, there are not only those holding elements 9 that cover the permanent magnets 4 on their outer surfaces 7 exclusively in a section that is located centrally relative to the circumferential direction of the rotor 1, but there are also those holding elements 9 that cover the two adjacent permanent magnets 4 on each of their side surfaces 8 that are next to each other. This allows a larger number of holding elements 9 to be provided, as a result of which it is possible to attain a sufficiently secure connection of the permanent magnets 4 to the core 3, even in the case of holding elements 9 that have been dimensioned so as to be relatively weak. The covering of the side surfaces 8—which run in one plane—of the permanent magnets 4, which are configured with rectangular cross-sectional surfaces in the form of block magnets in these configurations as well, is the result of an arrangement of these side surfaces so that they are slanted relative to an exactly radial orientation in such a way that the distance of adjacent side surfaces 8 of neighboring permanent magnets 3 increases as the radial distance of the axis of rotation 12 of the rotor 1 increases. This can be seen especially in FIGS. 8 and 9.

Concretely speaking, in the case of the rotors 1 as shown in FIGS. 7 to 9, it is provided that all of the holding elements 9, starting from the first front faces of the permanent magnets 4 and of the core 3, extend over the entire lengthwise extension of the permanent magnets 4, whereby the holding elements 9, in turn, are configured so as to be formed in one piece with a connecting ring 10 that rests loosely on these first front faces. In order to attain the highest possible strength of the holding elements 9 against radial expansion, it is also provided that at least those holding elements 9 that cover the appertaining permanent magnets 4 exclusively in a section of their outer surfaces that is located centrally relative to the circumferential direction of the rotor 1 are connected directly to each other in the area of the second front faces of the permanent magnets 4 and of the core 3 (see FIG. 9) or else they are indirectly connected to each other (see FIGS. 7 and 8).

When it comes to the rotor 1 as shown in FIGS. 7 and 8, this is done by means of radially oriented connecting hooks 13 which are arranged on the appertaining lengthwise axial ends and in which there is another connecting ring 10 that, in the concrete embodiment, is configured in the form of a conventional O-ring made of an elastomer. When this connecting ring 10 is in its mounted state, it is elastically pre-tensioned or expanded in order to exert sufficient pressure to press those holding elements 9 that comprise the connecting hooks 13 against the associated permanent magnets 4. Fundamentally speaking, it is also possible that exclusively, or else especially preferably additionally, the other holding elements 9 that cover the associated permanent magnets 4 at the appertaining side surface 8 are also provided with corresponding connecting hooks 13 into which the elastic connecting ring 10 is inserted.

As an alternative or in addition to the use of a connecting ring 10 in the form of an O-ring, it is also possible to employ a connecting ring 10 made of another material, especially of (another) plastic or else of metal, for example, also in the form of a wire which is inserted once or multiple times through the connecting hooks 13 and whose ends are joined together.

In the case of the rotor 1 shown in FIG. 9, in contrast, it is provided that the holding elements 9—at their corresponding lengthwise axial ends—have a connecting web 14 which runs in the circumferential direction and whose ends, which are located in the circumferential direction, are both configured in the shape of hooks and thus serve as connecting hooks 13. Here, however, these connecting hooks 13 are provided and appropriately configured to engage with the adjacent connecting hooks 13 of a neighboring connecting web 14 so that, under the effect of a radially expanding load, they bring about a reciprocal support of at least those holding elements 9 that cover each of the appertaining permanent magnets 4 exclusively in a section of their outer surfaces 7 that is located centrally relative to the circumferential direction of the rotor 1. In order to effectuate an appropriate support, also for those holding elements 9 that cover the associated permanent magnets 4 on a side surface 8, it can be provided, for instance, that the connecting webs 14 are additionally connected to these holding elements 9 or are configured in one piece with them.

In order to achieve an axial positional fixation of the holding elements 9 or of the units—configured in one piece and comprising the connecting rings 10, the holding elements 9, the connecting webs 14 (in the case of rotor 1 as shown in FIG. 1) and the connecting hooks 13 on or relative to the permanent magnets 4 and the core 3 that supports them—at least the connecting hooks 13 extend radially towards the inside to such an extent that they partially cover the front face of the core 3 there, so that they serve as stops that act in the lengthwise axial direction.

### LIST OF REFERENCE NUMERALS

1 rotor
2 rotor shaft
3 core
4 permanent magnet
5 tubular sheath
6 stator
7 outer surface of a permanent magnet
8 side surface of a permanent magnet
9 holding element
10 connecting ring
11 projection
12 axis of rotation of the rotor
13 connecting hook
14 connecting web

1. A rotor for an electric machine, comprising:
a rotor shaft,
a core that is non-rotatably connected to the rotor shaft and that surrounds the rotor shaft,
a plurality of permanent magnets that are connected to the core in a ring-shaped arrangement on the outside, and
a plurality of web-shaped holding elements, each of which makes contact with at least one of the permanent magnets on the outside in certain sections, wherein the holding elements cover each of the associated permanent magnet(s), either on an outer surface thereof exclusively in a section that is located centrally relative to a circumferential direction of the rotor or else exclusively on a side surface of each associated permanent magnet(s).

2. The rotor according to claim 1, wherein the permanent magnets are covered on the outside exclusively by the holding elements.

3. The rotor according to claim 1, wherein the permanent magnets have cross-sectional surfaces that are rectangular or in the form of circular ring segments.

4. The rotor according to claim 1, wherein at least some of the holding elements extend from the two front faces of the core only in certain sections over the lengthwise extension of the associated permanent magnet(s), said extension running along the axis of rotation of the rotor.

5. The rotor according to claim 4, wherein, in each case, two holding elements coming from different front faces are connected to each other in such a way that they reciprocally support a radial load onto the two holding elements.

6. The rotor according to claim 1, wherein at least some of the holding elements extend completely along the lengthwise extension of the associated permanent magnet(s) and are connected to each other directly or indirectly at one or both front faces of the permanent magnets in such a way that they reciprocally support a radial load onto the holding elements that is oriented towards the outside.

7. The rotor according to claim 1, wherein at least some of the holding elements are attached to a connecting ring, at least at one of their lengthwise axial ends.

8. The rotor according to claim 1, wherein at least some of the holding elements and/or the connecting ring(s) are made of plastic.

9. An electric machine having a rotor according to claim 1 and having a stator that surrounds the rotor.

10. The electric machine according to claim 9, wherein the stator delimits a cylindrical inner volume.
